(19) United States
(12) Patent Application Publication
(10) Pub. No.: US 2005/0060179 A1
(43) Pub. Date: Mar. 17, 2005

(54) Mobile report capture

(75) Inventors: Rickard Jon Tinberg, West Ryde (AU); Robi Mark Rogerson, Sydney (AU); Luca Bordin, Warrimoo (AU)

Correspondence Address: AKERMAN SENTERFITT, P.O. BOX 3188, WEST PALM BEACH, FL, 33402-3188, US

(73) Assignee: Valorem Systems Pty Limited, Seven Hills (AU)

(21) Appl. No.: 10/939,770

(22) Filed: Sep. 13, 2004

(30) Foreign Application Priority Data
Sep. 12, 2003 (AU) AU 2003246060

(51) Int. Cl. G06F 17/60

(52) U.S. Cl. 705/1

(57) ABSTRACT

A method of generating and managing property reports, in which a report is generated using a remote device at the place of inspection or occurrence, said device including an image capture function, said report including both written and image data wherein the date and time of creation of both said data are recorded and related to each other.

### TECHNICAL FIELD

The present invention relates to the preparation of property reports using handheld computer devices.

### BACKGROUND ART

In many practical situations it is required that a report be produced in relation to a physical occurrence. For example, a representative of an insurance company may attend a building in order to prepare a report on damage. Similar reports may be required for inspection of rental properties, building management in multi-tenant situations, assessment of car damage, quality assessment in cleaning situations, assessing premises after reports of an injury or the like. Such reports where there is a degree of physical inspection as well as an accompanying written report will be referred to as property reports in the specification and claims. The report may relate to fixed installations, moveable property, or any other situation requiring inspection or reporting.

At present, these reports are largely hand written. This introduces a delay until they are available for analysis by supervisors and management, as someone has to physically enter the report into the system. Moreover, there is a risk that the reports may be erroneously transcribed between the hand written report and the system. From a management perspective, it is highly advantageous if reports use standard terminology so that charts, statistics and summary reports can be readily compiled.

A further risk with such hand written reports is that they may not reflect the actual situation of the matter being inspected. For example, an inspector may simply telephone the building manager and acquire details when in fact he is required to physically inspect the damage. With a hand written report system it is not easy to determine that such an irregularity has occurred. Similarly, it is possible in some situations for a report to be altered after it is prepared. This operation may be an innocent rectification of a mistake or it may be of a more suspicious nature. In any event, it is desirable to create a situation where it is difficult for an inspector to create a potentially falsifiable report, so as to minimise the need to be concerned with any such management issues.

It is object of the present invention to provide a method for generating and managing property reports so that the reports are verifiable and can be managed electronically.

### SUMMARY OF THE INVENTION

Broadly, the present invention provides a method of generating and managing property reports, in which the report is generated at the place of inspection, and includes both written and image data, the date and time of both being known and able to be related together. An advantage of such an arrangement is that the image and related text data must be closely contemporaneous and cannot be subsequently altered, at least without a record of such alteration being made. This means that the person providing the report must physically have been present at the nominated place, taken an image of it and recorded the relevant details at more or less the same time. The report accordingly cannot be later altered, and must be completed at or close to the time the image is taken. This provides a inherent check of the reliability of the report.

According to one aspect, the present invention provides a system for generating and managing property reports, in which a report is generated using a remote device at the place of inspection or occurrence, said device including an image capture function, said report including both written and image data, wherein the date and time of creation of both said data are recorded and related to each other.

According to another aspect, the present invention provides a method of generating a property report, including at least the steps of:
a) providing a handheld computing device including a predetermined report format accessible to the user;
b) the user taking said device to a required location;
c) the user commencing the preparation of a report using said predetermined format, said report preparation including taking a digital image with said device;
d) the device retaining text and image data integrated into said report together with an indication of the time and date each of said data was entered; and
collating said data into a format suitable for an upload to a control device.

It is noted that the order of the photo or text being acquired is not critical. It is desired that they be integrated into a single report. It is further noted that the image data may be a digital image, or video data. Additionally, further forms of data could be captured appropriate to the situation, including recorded voice or audio or authorising signatures of personnel at the site, and integrated into the report. The time and date of this further data could also be integrated.

In a preferred embodiment, the device is docked with an appropriate cradle, and the data is transferred to a PC running appropriate software, so that the report data is compiled and uploaded via a web based application to a remote database. Alternatively, the present invention would be implemented wherein a direct wireless link is provided from the handheld computer device to upload the data, or whether the data is uploaded via a suitable connection, for example, blue tooth link, through a mobile telephone for direct uplink. The method of uploading may be any suitable communications path.

The handheld computer device is preferably one which accepts text input, and has a integrated digital camera. One suitable device is the Sony Clie or Palm Zire71. However, the present invention is not limited to any particular implementation or hardware system. It could be implemented using a suitable mobile telephone, and PDA type device, a notebook or tablet computer, or any other suitable portable device with the appropriate functionality.

In a preferred form, the report formats can be specified by a suitably authorised administrator. These report formats are downloaded to the PC's, and then to the appropriate handheld devices. It will be appreciated that for use in handheld device, it is highly desirable that as much information as possible is characterised into check boxes, pull down menus or the like. Consistency of reporting is thereby achieved. Some of the relevant data for each report could also be downloaded—for example, the addresses and basic report information which leads to the property report being required.

It would be apparent that an advantage of the present invention is that as the time relationship between the image and the text will be apparent to anyone reviewing a report, it can be verified that they are more or less contemporaneous. Hence, it would be difficult to substitute a photograph taken earlier or later for the direct photograph. Even if this did occur, the details on the photograph would need to match what is described in the text. The photographic evidence itself may be useful. For example, it may be determined that it is very commonly the same window which is being broken in a particular building. Accordingly, consideration could be given to a grill or tougher form of glass.

It is also preferred that the report is in a standard format which can therefore be more readily uploaded and dealt with in a standard way by a management system.

### BRIEF DESCRIPTION OF THE DRAWINGS

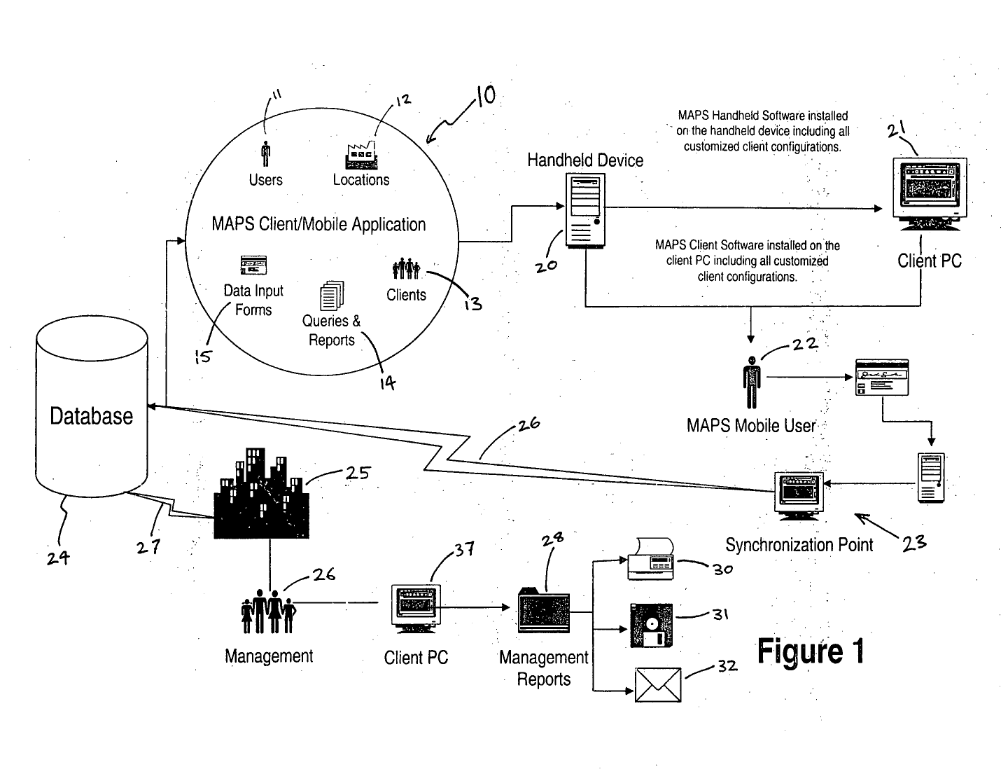

The present invention will be further described with reference to the accompanying figure, in which FIG. 1 illustrates the overall logical arrangement of the present invention.

### DETAILED DESCRIPTION

The present invention will be described with reference to a particular application. It will be appreciated however, that the present invention is not limited to any particular operating systems or proprietary devices. Rather, the invention is at a more functional level. It should further be appreciated that the present invention can readily have further features added to it as the functionality of handheld computers, and the costs thereof, change over time. All such straight forward additions and modifications fall within the scope of the present invention.

Further, it is noted that the example described below may need to be altered in detail or in substance, depending upon the specific capabilities and software of the particular hand held device used.

Considering FIG. 1, we will first discuss the client software 10. The client software is specifically configured for specific users 11 and locations 12. Specific data input forms 15 and queries and reports 14 have been set up, and specified by management 26. This software resides upon handheld device 20. Via a cradle (not shown) or other communication mechanism, the device communicates with a local PC. The PC may download additional input forms and information, for example, appointments, to a handheld device. The handheld device upload reports to the PC.

A mobile user 22 takes the handheld device 20 to the site where a property report is required. Depending upon the specified report format, at least text data and image data are required. There may be multiple image fields. If appropriate, information acquired could include voice, or signature data. Voice data may be, for example, a description of how an incident occurred by a witness. Signature data may be, for example, a sign off on an insurance report by a representative of a building owner. Other forms of data, time stamped or not, could include GPS or other positional data, barcodes, RFID reader outputs, or any other desired data which can be accessed by the handled device 20. Some data may be measured and manually entered—for example, measurement of distances, temperatures or the like.

Once the report is collected, it is time and date stamped and locked so that the user may not modify it any further. In one form, after each field is filled, that field can no longer be amended. In another version, the user after a final review of the report selects a “save record” button or checkbox, and the report is then completed and locked.

In practice, the mobile user may have collected many of these reports in the course of a day's work. In one form, not illustrated, the report is directly uploaded via a wireless link. This could be triggered by the user indicating that a report was completed. In the version indicated in FIG. 1, the user returns to a synchronisation point and cradles the handheld device 20 so as to communicate with synchronisation point 23 (which may be the same as client PC 21). Via communication path 26, the data is directly or indirectly uploaded from the handheld device via the synchronisation point 23 to database 24. In practice, many different mobile users 22 may be uploading data to the database. The database information is then (instantly) made available, preferably via the internet or a similar network, at the locations required by the customer. Management 26 via PC 37 is enabled to query the database to produce appropriate queries, reports, summaries and so forth as specified. These can be readily customised to the industry in question. Reports can then be printed out, saved 31 or emailed 32 as required.

The preferred platform for the hand held device is currently the Palm Zire71, which operates on a Palm operating system. The application on the device provides at least the following functionality:
Unique record automatic numbering
Time and date stamping upon opening of the new record
Locking of records upon confirmation of the completion of record
Time stamping on the completion confirmation of the completion of record
Notes entry
Seamless image, capture and integration to the record
Log on and off on the Palm Zire71—User and password based
Client specific Palm Zire71 interface
Dynamic pick lists
Signature capture in record
Image Mark up (a pro-determined image loaded into a form as a question that a user is able to draw on and mark up ie. A diagram of a car that you can draw on to show where the damage is).
Desktop synchronisation
Help

It will be understood that the handheld device could be a suitably enabled mobile telephone or any other functionally equivalent portable device. It is to be expected that the manufacturers will add functionality to such devices over time, and these features may be advantageously used in conjunction with the present invention.

The preferred implementation uses software loaded onto a PC to interface to the hand held device on the one hand, and to the database on the other. The software is preferably customised to the requirements of a particular user organisation, and loaded to the desktop or server hardware. The desktop hardware includes the Palm cradle or cable. Of course, depending upon the device, this could be a blue tooth or similar link, an IR link, a wireless LAN link, or any suitable communication means which can upload the relevant data. The desktop interface preferably provides the following functionality:
Seamless synchronisation with the handheld device software
Customised reports and queries
Client specific interface—Client specific locations, users, clients, forms, reports and queries
User log on and off—password based
Printing
Administration functionality to allow primary user to customise data downloads to field units
Help

The software at enterprise control level is preferably customised for each client and loaded for use by management. This will generally be on a hardware platform using a PC and a Palm cradle or cable. The enterprise interface will preferably provide the following functionality:
Seamless synchronisation with the handheld devices
Customised reports and queries
Client specific interface—Client specific locations, users, clients, forms, reports and queries
User log on and off—password based
Printing
Administration functionality to allow primary user to customise data downloads to field units
Web/WAN/LAN/intranet database storage
Multiple user connectivity for synchronisation and reporting user access levels.

It will be appreciated that whilst the software for the handheld device and at the enterprise control level is preferably customised for the enterprise, the present invention could be implemented in a way which is less customised. For example, a generic solution could be provided for a particular industry, for which only a more limited degree of customisation is provided.

The following description is intended to describe the operating procedures for one implementation of the present invention. It will be appreciated that the concept of permitting a high degree of customisation is one of the advantages of the present invention, and that accordingly it is to be understood that many and varied implementations are possible.

Following is a description of the operation of the handheld device. Upon power on an initial screen appears and displays a logon for the user. Once the user has logged on, the user is shown a screen containing the application icons.

Suitable application icons may include: Calendar, Address Book, Calculator, Note Pad, Password Change, Synchronisation, Logoff and Preferences. An icon specific to the present application, called MAPS, also appears. Upon clicking on the MAPS icon, the forms choice screen is displayed, with icons for each report. If the user has data to review, a review icon is also displayed.

When the user selects a form, and taps the New Record button a New Record input screen will appear.

On creation of the new record, time stamp, date stamp, user ID and location the user has logged in under of the record will be established and saved securely. The user does not see this information. The input screen shows a field header and any associated field attributes, for example a Notes icon and a checkbox ticked if notes attached or image icon and checkbox ticked if image is attached. If the checkboxes are not checked, the user is taken to the required input screen for notes or image and allow the user to input data. Once these checkboxes are confirmed, the user is returned to the Record. The fields in the record are pre-defined for the enterprise. As far as possible, the record fields are checkbox or pull down menu based to provide consistency of data. The cursor moves down to the next field once the previous field data has been entered and saved by the user. At the end, selecting a checkbox or button for confirmation of record complete will lock the record and time stamp it. It is preferred that the form have a cancel or delete feature available for mistakes, but that this not function after the record has been confirmed complete. Depending upon the application, it may be useful or required for users to be able to view a pre-loaded image and make notes on the image utilising paint functionality. For example, a line drawing of a motor vehicle could be provided within a report for vehicle damage assessment. A preloaded floor plan could be used to indicate the area where a deficiency in cleaning has been identified.

Upon clicking the Review data icon the user is taken to a screen showing all records for that specific report. Clicking on the record will take the user to the required record and give them read only access to the record. The date and time are displayed at the top of each record. Find functions are preferably provided, as would be expected within documents.

A synchronisation button appears on the main screen. This allows for the data in the hand held device to be synchronised with the PC, once the device is cradled and both the PC and device are active. A password change options icon should also appear on the main screen. If a user requires help information there is an information/help icon to use at anytime.

The desktop interface provides both the end user client interface and an administrator interface, and these will be discussed separately.

The user interface allows users with appropriate privileges to logon via a web interface (internet/intranet) to perform tasks and view information. Upon opening the application in the PC, a user logon appears. After logon, the user is shown a screen containing icons for Reviewing Data. A user can synchronise data at any time by connecting a handheld device to a client PC and hitting the Synchronization button on the device. This uploads the data on the handheld unit to the database and then removes the data from the device ensuring the device is ready to go back into the field.

By selecting the Review Data icon the user is shown the specific reports complied for them. The user can then view the customized queries and if they wish can export these queries into the customised report templates and print out the required reports. The user can also email specific reports or records from within the application. The reports are preferably exported in a common format such as MS Word or Excel or PDF. The user can also download specific reports and queries to the handheld for future reference.

The System Administrator requires a broader set of authorities to enable the best use of the system for the enterprise. The administrator is able to:
Create, edit and set user permissions
Use the desktop
Use handheld
Create/Modify Users
Create/Modify Forms
Create/Modify Reports
Create/Modify Queries
Create/Modify Report Templates

The enterprise control level software ensures that the system functions as required for an enterprise. This includes a ability to modify the records on the desktop, ensure capture of user name, set initial password assignments, force each user to change password after specific time frame, and similar operational aspects.

The enterprise control level software is used to create new forms, including design, format etc for specific report formatting requirements. It is important to the effective implementation of the present invention that great care is taken in setting up the reports to enable on the one hand efficient data input in the field, and on the other hand the consistency and ease of data analysis once the data is returned to the enterprise control system.

The enterprise level system is able to edit forms, delete forms and define and use various field types. These may include text, image, video, voice, notes (for descriptions), numbers, pick lists, check boxes, signature capture and pre-loaded images.

It is also required lo allow for the establishment of new clients. In this situation, the administrator needs to be able to undertake tasks such as:
Define for each new client, name, address etc fields
Assign Users to a specific client
Assign Forms to a specific client
Assign Reports and queries to a specific client
View and assign reports for a client

The process of report creation, based on the data collected in the field and sent back to the host database, is critical to obtaining the benefits of the present invention. The report creation function supports functions including:
Define input parameters
Layout—set specifics for formatting i.e. date, time header footer
Definition of any calculations required to produce customised reports that graph data
Email to specific location
Print off reports

It will be understood that the present invention can be applied to many situations, for example:
Reports about building damage
Quality assurance for cleaning
Insurance assessment, for buildings, vehicles, etc
Livestock inspection reports
Local government issues for example breaches of access restrictions
Water restriction enforcement
Inspection of rental premises

The present invention may be implemented on a variety of platforms, with additions and variations enabled by the device chosen, and the application required.

1. A system for generating and managing property reports, in which a report is generated using a remote device at the place of inspection or occurrence, said device including an image capture function, said report including both written and image data wherein the date and time of creation of both said data are recorded and related to each other.

2. A system according to claim 1, wherein the report is generated such that after a predetermined step the data cannot be revised by a user.

3. A system according to claim 1, wherein the report is generated using a predetermined format.

4. A system according to claim 3, wherein said predetermined format includes multiple fields, said fields specifying a data type, wherein said fields include at least data types being written data and image data, so that multiple fields may specify the same data type.

5. A system according to claim 4, wherein the fields also specify other data types.

6. A system according to claim 5, wherein said other data types include one or more of audio, images, numbers, signatures, GPS or other position data, barcodes, RFID, and pre-loaded images.

7. A method for generating a property report, including at least the steps of:
a) providing a handheld computing device including a predetermined report format accessible to the user;
b) the user taking said device to a required location;
c) the user commencing the preparation of a report using said predetermined format, said report preparation including taking a digital image with said device;
d) the device retaining text and image data integrated into a report document together with an indication of the time and date said data was entered; and
e) collating said data in a form suitable for an upload to a control device.

8. A method according to claim 7, wherein the report is generated using a predetermined format.

9. A method according to claim 8, wherein said predetermined format includes multiple fields, said fields specifying a data type, wherein said fields include at least data types being written data and image data, so that multiple fields may specify the same data type.

10. A method according to claim 9, wherein the fields also specify other data types.

11. A method according to claim 10, wherein said other data types include one or more of audio, images, numbers, signatures, GPS or other position data, barcodes, RFID, and pre-loaded images.

12. A method according to claim 7, wherein after a predetermined step the data cannot be altered by the user.

13. A system according to claim 2, wherein the report is generated using a predetermined format.

14. A method according to claim 8, wherein after a predetermined step the data cannot be altered by the user.

15. A method according to claim 9, wherein after a predetermined step the data cannot be altered by the user.

16. A method according to claim 10, wherein after a predetermined step the data cannot be altered by the user.

17. A method according to claim 11, wherein after a predetermined step the data cannot be altered by the user.
